(19) United States
(12) Patent Application Publication
(10) Pub. No.: US 2016/0063198 A1
(43) Pub. Date: Mar. 3, 2016

(54) HEALTH CARE MARKETPLACE AND METHOD OF GENERATING REVENUES THEREFROM

(71) Applicants: Karen Elaine Ferrell, Alpharetta, GA (US); Bradley Alan Keywell, Glencoe, IL (US); Lee Allen Shapiro, Wilmette, IL (US); Glen Edward Tullman, Wilmette, IL (US)

(72) Inventors: Karen Elaine Ferrell, Alpharetta, GA (US); Bradley Alan Keywell, Glencoe, IL (US); Lee Allen Shapiro, Wilmette, IL (US); Glen Edward Tullman, Wilmette, IL (US)

(21) Appl. No.: 14/729,792

(22) Filed: Jun. 3, 2015

Related U.S. Application Data
(63) Continuation-in-part of application No. 14/539,703, filed on Nov. 12, 2014.
(60) Provisional application No. 61/903,271, filed on Nov. 12, 2013.
(60) Provisional application No. 62/007,258, filed on Jun. 3, 2014.

(51) Int. Cl. G06F 19/00; H04L 29/08; H04L 29/06

(52) U.S. Cl. CPC G06F 19/328; H04L 67/42; H04L 67/02

(57) ABSTRACT

The present invention relates to a software platform, designed preferentially for portable phones (App format) to offer customers in need of health care services, and health-associated services and goods a marketplace where these two types of services and goods can be purchased more efficiently. More specifically, the platform relates to a purchasing web interface where a points-based incentive program operates alongside a group purchase system.

### RELATED APPLICATIONS

This application is a continuation-in-part of and claims the benefit of and priority from U.S. Application Ser. No. 14/539,703, filed Nov. 12, 2014, which claims the benefit of U.S. Provisional Application No. 61/903,271, filed Nov. 12, 2013. This application claims the benefit of U.S. Provisional Application No. 62/007,258, filed Jun. 3, 2014. Each of the foregoing applications is hereby fully incorporated herein by reference.

### FIELD OF THE INVENTION

The present invention relates to a software platform, designed preferentially for portable phones (App format) to offer customers in need of health care services, and health-associated services and goods a marketplace where these two types of services and goods can be purchased more efficiently. More specifically, the platform relates to a purchasing web interference where a points-based incentive operates alongside a group purchase system.

### BACKGROUND

One of the most famous restaurant reservation system is called Opentable.com. Restaurant owners who wish to generate traffic to their establishment in off-hours join the interface. They then open certain tables for reservation via the interface. Each reservation is given a time increment of 30 minutes. Restaurant owners pay for each reservation in one of many ways. For example, a fixed fee (i.e. $5) can be requested. In turn, Opentable.com uses this fee to build and maintain the interface, and give ‘points’ to users for frequent reservation via the interface. For example, some reservations can give a user 100 points, while others can give 1,000 points. Opentable.com then gives the user a check each time it accumulates 10,000 points (at the moment $100) to be redeemed in any of the Opentable.com participating restaurants.

One other well-known modern way to monetize services is the Groupon® model. In this model made famous over the internet, an online service provider offers a reduced price deal for services or goods. The offer is only valid for a fixed number of customers (i.e. 100 coupons). Once purchased via the interface, the online provider keeps a fraction of the paid price by the online clients and transfers the rest to the service/good provider. The service/good provider then will be handed a printed or digital copy of the coupon by the customer visiting the online or physical location where services/goods are then given for free (since they have been paid to the coupon issuer). The advantage of this model is for the service/goods provider to instantly monetize the services/goods and hope that some of the beneficiaries do not collect their benefits within the allocated time period. In the case of restaurant services, a location may issue 100 coupons for a value of $100 each. They would be sold at the price of $50. The online interface provider would keep $10 and pass along $40 to the restaurant owner. One advantage of these types of rebates is the capacity of some individuals to visit the restaurant and order for a value greater than the coupon. On this excess value, the restaurant owner will charge full price.

Both of the systems described above rely on one of two very distinct incentive systems, either a point-based incensive reward, or a heavily discounted grouped purchasing system. One advantage of the point-based system is its simplicity but requires repeat users as is the case with the purchase of restaurant services. Each of these systems, while popular and meeting their needs in their respective segments, are far from perfect and applicable to other more complex fields.

### SUMMARY

What is contemplated in the current invention is a dual system, where on each of the two parrallel systems, a different incentive is offered, and where both incentives are crossed in interest. The system, called possibly the HealthMalls^{SM} has two distinct tracks. The first offers different goods/services each health-related. For example, these goods and services can include different contacts to massages, healthy foods, health-related equipment, trips, etc. A user can buy directly goods/services using this track, but may also use ‘Zest-bucks’ which are credit-based points given to the user either for a purchase on this track or the second track described below.

The second portion of the software application is designed to be a menu where different expensive health care related services are offered at a grouped/discounted rate. For example, some tests or other services can come with a high deductible, or some patients may be faced with price quotas or limitations. For example, the average cost of an Abdominal MRI cost is $2,625.00 in the Chicago Area. The person offering the online interface services contacts MRI service providers and negotiates either a group rate (i.e. 30% off in certain locations), a rate discounted based on the moment the service is available (i.e. 30% off from 6 to 7 pm), or a combination of both.

In addition to offering these services at a discounted rate, what is contemplated is the offering to the user on one side of credits they can use on the other side and vice-versa. For example, the online interface provider may contact an MRI service provider. This provider has peak hours and off-peak hours. Wanting to drive off-hour customers, the MRI signs up with the online interface and releases for the next week 20 appointments in the hours of 8 to 12 pm at night. While these services are normally charged X, they are offered on the interface at a discounted rate of X−30%. In addition, a user can buy one of these deals which in turn will earn it X credits in the interface. These credits will then be usable in the rest of the interface to buy in full any good/service, or as the basis of a price reduction of the good/service.

### BRIEF DESCRIPTION OF THE DRAWINGS

Certain embodiments are shown in the drawings. However, it is understood that the present disclosure is not limited to the arrangements and instrumentalities shown in the attached drawings.

FIG. 1 illustrates the different actors involved the procurement and use of health care insurance according to an embodiment of the present disclosure.

FIG. 2 is an illustration of the hardware associated with the system described at FIG. 1 according to an embodiment of the present disclosure.

FIG. 3 is an illustration of one possible software layer to be used in the hardware shown at FIG. 2 to implement the system shown at FIG. 1.

FIG. 4 is an illustration of the different communication protocols associated with the software at FIG. 3 that also illustrates the different protection protocols according to an embodiment of the present disclosure.

FIG. 5 is a graph illustrating cost-saving reductions contemplated by the use of this invention according to an embodiment of the present disclosure.

FIG. 6 is a diagrammatic representation of the different actors using the system of the current invention according to an embodiment of the present disclosure.

FIG. 7 is a screen shot of the four main elements of the new software system according to an embodiment of the present disclosure.

FIG. 8 is a screen shot of the first of the four elements shown at FIG. 7 according to an embodiment of the present disclosure.

FIG. 9 is a screen shot of the fourth of the four elements shown at FIG. 7 according to an embodiment of the present disclosure.

FIG. 10 is a screen shot of the second of the four elements shown at FIG. 7 according to an embodiment of the present disclosure.

FIG. 11 is a screen shot of the third of the four elements shown at FIG. 7 according to an embodiment of the present disclosure.

FIG. 12 is a diagram representing the strategy purchasing method according to an embodiment of the present disclosure.

FIGS. 13A to 13C represent three screen shots highlighting an advertising and notice area as part of a software display according to an embodiment of the present disclosure.

FIG. 14 is a screen shot of an app software display of the health care services optimization platform showing the “talk to me” element according to an embodiment of the present disclosure.

FIGS. 15A to 15H are multiple screen shots of an app software display of the health care services optimization platform showing the “evaluate me” element according to an embodiment of the present disclosure.

FIGS. 16A-16C are multiple screen shots of an app software display of the health care services optimization platform showing the “inform me” element according to an embodiment of the present disclosure.

FIGS. 17A-17F and 18A-18H are multiple screen shots of an app software display of the health care services optimization platform showing the “schedule me” element according to an embodiment of the present disclosure.

FIG. 19 is a screen shot of an app software display of the health care services optimization platform showing the reward points system according to an embodiment of the present disclosure.

FIGS. 20A and 20B are multiple screen shots of an app software display of the health care services optimization platform showing the “my profile” element according to an embodiment of the present disclosure.

FIGS. 21 and 22 illustrates the steps of a method for providing optimized health care services over a health care services optimization platform.

FIG. 23 illustrates the steps of a method for allowing strategic purchasing from supply vendors by a service facility using an optimized health care services optimization platform.

FIG. 24 is an illustration the Health Care Marketplace And Method Of Generating Revenues Therefrom.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

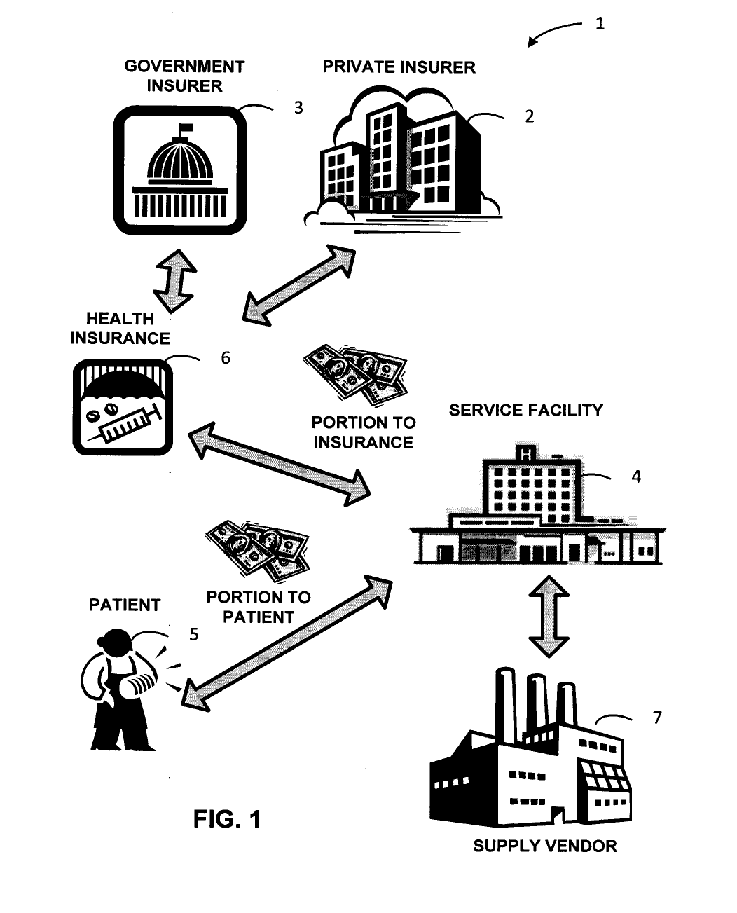

FIG. 1 illustrates from a distance part of the interactions in the highly complex overall process associated with the acquisition of health care services in the United States. In the health care process 1, a patient 5 having a need for medical services (illustrated here by a patient with cast) will seek to receive the services at one of multiple different service facilities 4, such as for example a hospital, a nursing home, a pharmacy, an ambulance or any other facility at which any type of health care—related services and associated goods can be offered. These facilities 4, in addition to providing services that in turn require goods, can also offer goods such as equipment, drugs, implants and other medical service—related goods to treat the patient 5. These goods are often supplied by a supply vendor 7. As shown at FIG. 1, a patient 5 may pay a portion of the costs directly to the service facility 4, or he or she may rely on health insurance 6 to pay a portion of the costs. The insurance 6 can be provided by multiple sources, including for example private insurers 2 or government insurers 3. Because of the importance of health care and the sheer volume of services offered each year, one of ordinary skill in the art will understand that each of these different elements shown at FIG. 1 describes each of these concepts with a high level of abstraction.

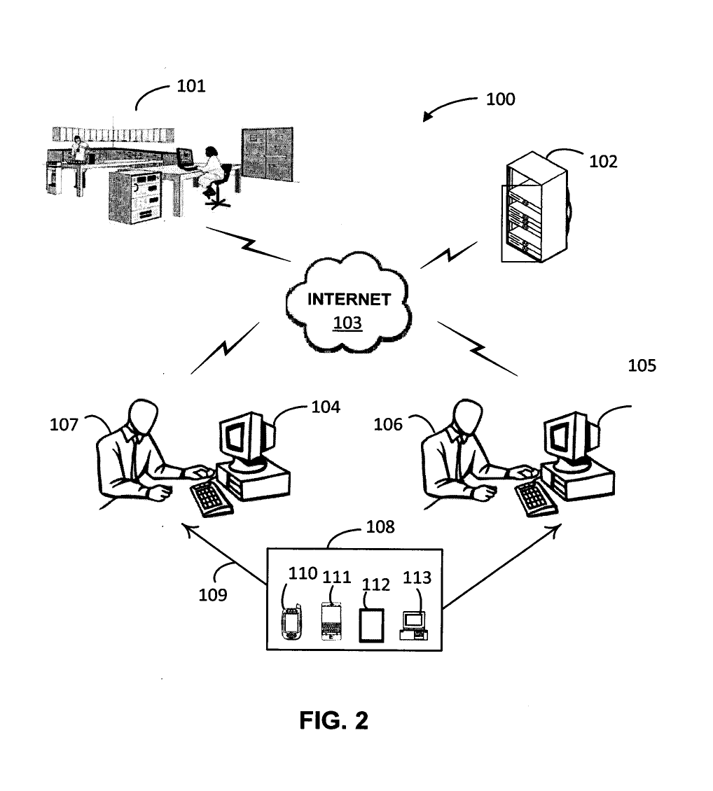

To implement the transfer of services and associated transfer of resources, what is used in the current invention is a fully automated or partly automated system 100 as shown at FIG. 2. FIG. 2 shows generally how in today's environment multiple parties 106, 107 can use computer stations 104, 105 equipped with a display, a user interface and a processor unit connected to a memory to execute software for use by the parties. As shown, these parties 106, 107 are now capable of using 109 portable devices 108 instead of a computer station 104, 105, for example handheld devices 110, 111, 112, 113 having transceivers to connect to wireless networks, or transceivers to connect via web servers to the Internet 103 or any other network. Generally, multiple different systems will be connected directly or indirectly to the parties' software, for example on a server 102. Different users 101 will then be able to connect remotely via the Internet 103 or other network communication systems to the different parties. The structure shown at FIG. 2 is illustrative only generally of the technology layer in the form of hardware used by the different parties, for example the parties at FIG. 1. As shown in this figure, an app store at which, for example, software apps can be purchased may be illustrated by the server 102.

One of ordinary skill in the art will understand that each of the government insurer 3, the private insurer 2, the service facility 4, the supply vendor 7 and the patient 5 shown at FIG. 1 may be equipped with some of the hardware illustrated at FIG. 2 as part of the process of acquiring health insurance 6, the process of payment and the process of securing services.

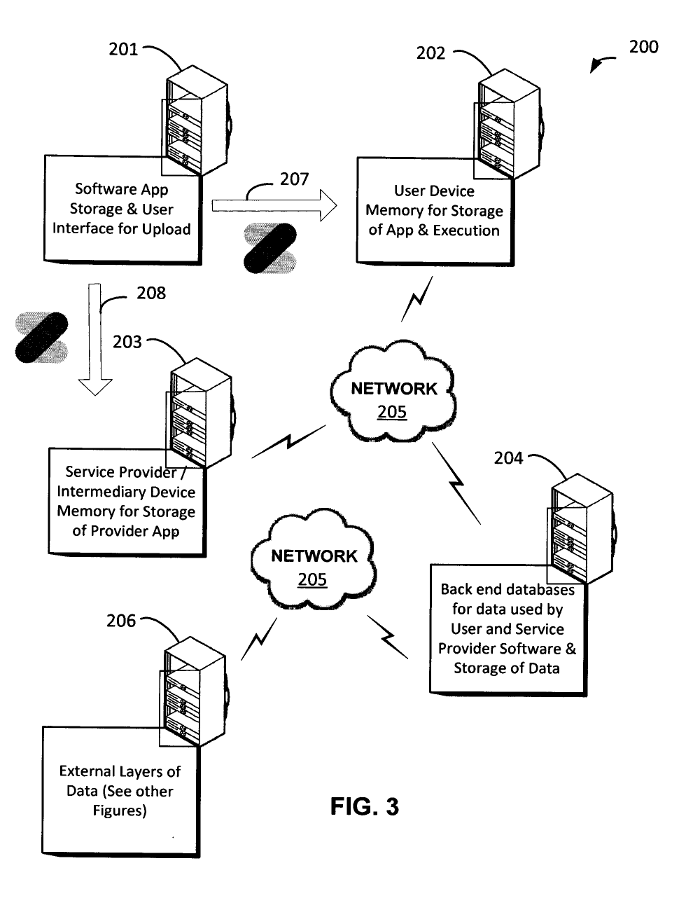

FIG. 3 illustrates one possible software layer made of multiple interlaced applications and layers of software found in servers and other types of hardware, for example the structure shown at FIG. 2 for services such as those described at FIG. 1. In the overall software system 200, a stand-alone executable program, such as an program in app format (called an app) is uploaded into a storage server 201, for example an app store. Users will then access the store on the server using the network 205 and receive via the normal interface either a user device version 207 or a service provider version 208 based on the type of party uploading the app from the server 201. In one embodiment, a single version of the app can be produced for upload irrespective of the type of party (user or service provider). The app is then stored on the memory of the storage device used by the user 202 and the memory of the service provider device 203. For example, a doctor and a nurse can upload the app from the app store 201 onto their own handheld devices 203. A patient can also upload the app from the store 201 into a handheld device 202 for access. As shown by the arrows around the network 205, the users and the service providers can then be connected to each other via the network, using the app as executed in the software layer of each device.

What is not shown is the computer software and hardware needed to create and upload the app to the app store 201. As with most Apps, once the software is made to execute, it can require either a regular data connection, regular updates or a live constant data connection with a back-end database that stores and makes the data available to the apps. The back-end server 204 can use any type of server and database commercially available on the market, for example an Oracle database. Data will then be exchanged between the different devices 201, 202, 203, and 204 using regular port technology, transceivers, wireless or non-wireless technology, and for example different HTML/API tools and layers to help with interface and communication of data. For example, the app of multiple users 202 may be programmed so at any moment at which a nurse or a doctor contact is initiated, the app will connect with the back-end database 204 and/or the status of the multiple service providers 203 to determine which link and connection should be immediately established or programmed for appointment. The data sent back to the doctor 203 may include client medical information and other relevant information. As the doctor and the patient use the network 205 to communicate, the doctor may use the software to help generate needed information from the database 204 or to get information about the user 202 from his/her device. While one structure of data communication is described, what is contemplated is the use of multiple devices, each with one or multiple versions of an app used and designed to exchange information together or with a back-end server.

Finally, FIG. 3 shows how other, generally remote external layers of data and information 206 can be connected to the system over the network 205. For example, in a case in which a physician's software layer 203 is engaged in a one-to-one communication with a patient's device software layer 202, the physician may have a need to schedule an appointment and reserve a X-ray room at his/her practice. Since the schedule of the room of his/her hospital is located on the server of the hospital and may not be found on the back-end database servicing the app directly, either the app in the physician's layer 203 can communicate via the network 205 with the hospital 206 and the appropriate database, or the back-end server 204 can be enabled to do so 206. The access of the different databases and their interconnections will be described hereafter.

The current disclosure relates to a system, software and hardware enabled in software that functions either in a new software layer or as pages of HTML format or other format in a browser of network information such as Internet information. This system is at the heart of a global, fully integrated platform in which patients (i.e., clients) can be connected directly with their doctors (users) as shown at FIG. 2. The system 100 relies generally on the Internet 103, where several elements 101, 102, 104 and 105 are connected. For example, in one embodiment, a user 105 using a fixed terminal 113, a portable tablet 112, a web-enabled phone 111 or a WAP-enabled phone 110 or any other device 108 to communicate with a patient 107 who is also using a device 104 such as a fixed terminal 113, a portable table 112, a web-enabled phone 111 or a WAP-enabled phone 110 or any other device 108.

The patient 107 communicates via software over the Internet 103 with a doctor 106 or any other medical service provider. As shown at FIG. 2, data can be used and merged into the system and software from different databases 102, each connected to the Internet directly or indirectly, or laboratories or service providers 101 as shown. One of ordinary skill in the art will recognize that while one configuration of use is shown, what is contemplated is any configuration.

FIG. 4 is an illustration of the different communication protocols associated with the software at FIG. 3 that also illustrates the different protection protocols according to an embodiment of the present disclosure. An administrator can use a portable computer and, using a first protocol such as HTTPS, can access a Windows® Azure® infrastructure. Within the infrastructure shown by the square line, either the administrator or a user of a portable station using an Android® or iOS® operating system can also connect within the infrastructure using HTTPS protocol or push/email a notification within the infrastructure.

In one embodiment, a Database Server VM, for example Windows® Server 2012 SQL Server Web Edition, connects to a bitlocker encrypted drive to create worker roles and web roles to help implement worker processes, administration portals, mobile application web services, etc. As shown, the use of encryption and heightened security is highly desirable because of the nature of the field, as personal and identifiable information of a medical nature is highly regulated. One of ordinary skill in the art will recognize that most of the software layers and hardware described comes with different levels of security and that this security, including but not limited to passwords, is contemplative of use.

FIG. 5 is a graph illustrating cost-saving reductions contemplated by the use of this invention according to an embodiment of the present disclosure. As shown, savings in health care costs can come from multiple different avenues, including narrow network and strategy contracting, benefit plan design, reduction of unnecessary emergency-room visits and disease management. By implementing all these different solutions simultaneously, cost savings can reach 8 to 15% nationwide.

FIG. 6 is a diagrammatic representation of the different actors using the system of the current invention according to an embodiment of the present disclosure. As shown above, a consumer in need of medical services, using one of multiple devices including a phone, a tablet or a computer, can contact a health care professional for triage, for example a nurse as shown to help schedule an appointment, transfer the call to a doctor, or direct to urgent care.

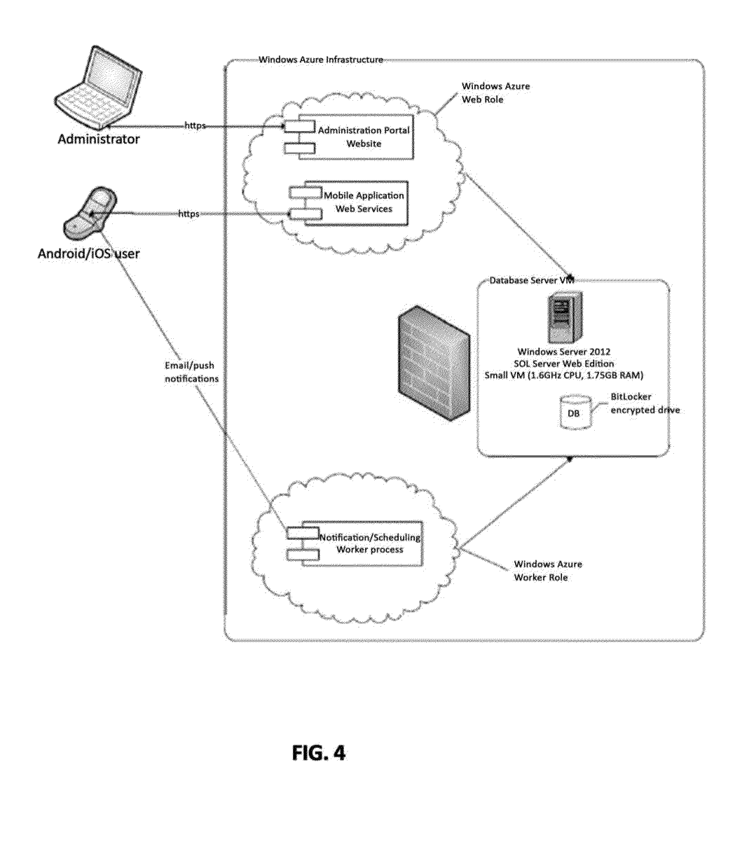

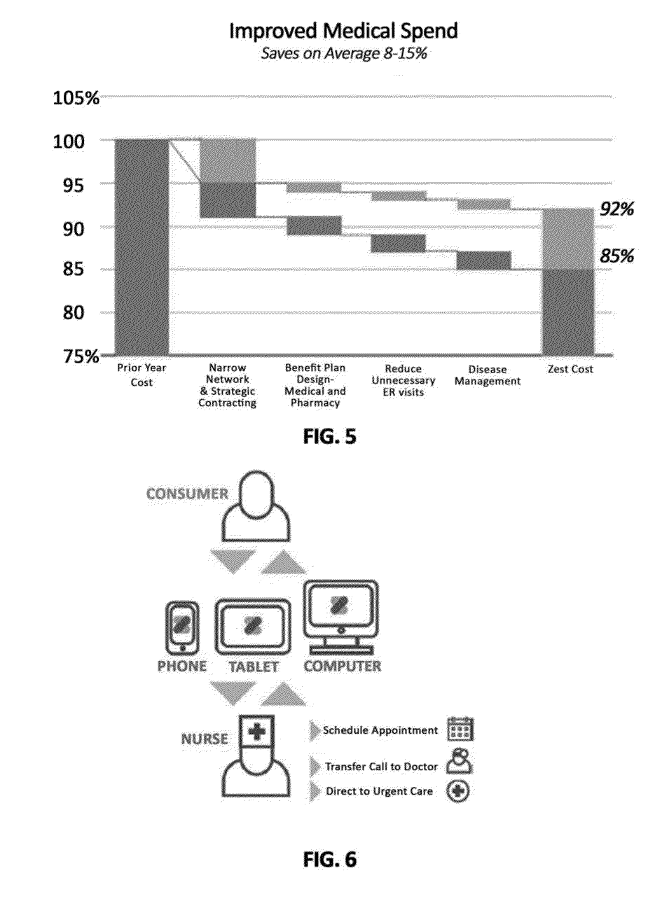

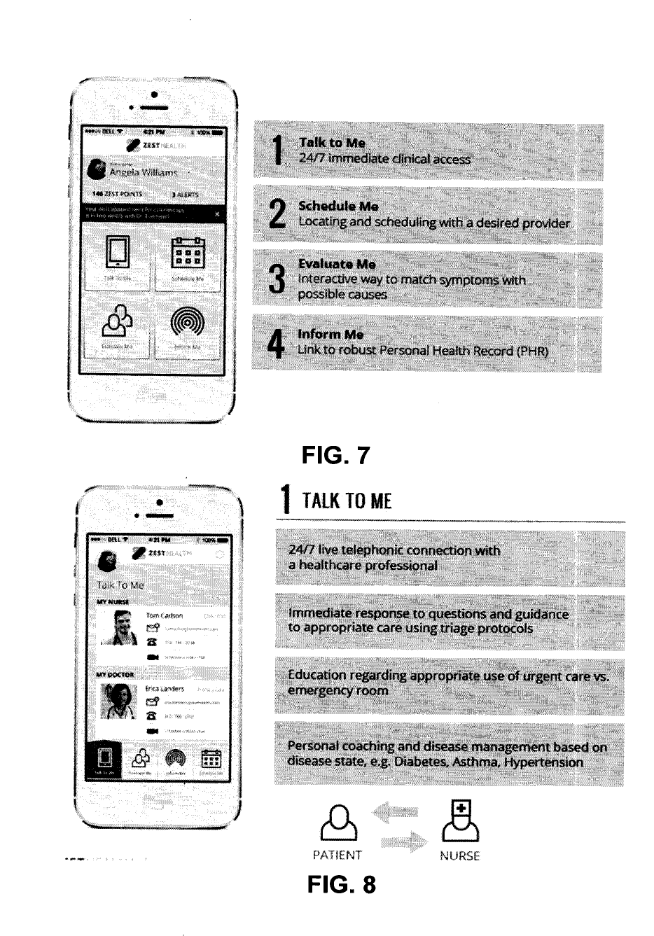

FIG. 7 is a screen shot of the four main elements of the new software system according to an embodiment of the present disclosure. This figure shows how a small app or any other type of software interface as described above can join several user specific-tools to help create a seamless and transparent health care service that enhances the overall experience, creates costs savings and helps a user implement new technology in a service historically reserved to live consultations and phone contacts. For example, the tool can include a “talk to me” button 301 for 24/7 immediate clinical access, a “schedule me” button 302 to locate and schedule a contact with a service provider, an “evaluate me” interactive interface 303 to help find and match symptoms and possible causes to help with the overall process, and an “inform me” button 304 to help link to robust databases to help a person acquire and secure robust Personal Health Records (PHR). Also as shown, a picture of the user along with the name of the user can be displayed to help a user understand that the interface is personal. As shown, alerts and award points can be used to further incentivize a user.

FIG. 8 is a screen shot of the first of the four elements 301 shown at FIG. 7 according to an embodiment of the present disclosure. Once a user touches the “talk to me” button 301, the interface as shown illustrates and guides the user by placing buttons. This function includes a 24/7 telephonic connection with a health care professional, for example a nurse 401 or a doctor 402 using the phone's normal communication line. This feature is enabled, for example, using the voice transceiver of the device over a network through which phone communication is possible. A patient can be given a picture of the health care professional along with contact information (e-mail address, phone number, etc.). Even a video chat is made possible using, for example, a proprietary third-party app communication system. This system allows immediate response to questions and guidance to appropriate care using triage protocols, education regarding appropriate use of urgent care versus an emergency room, and personal coaching and disease management based on disease state.

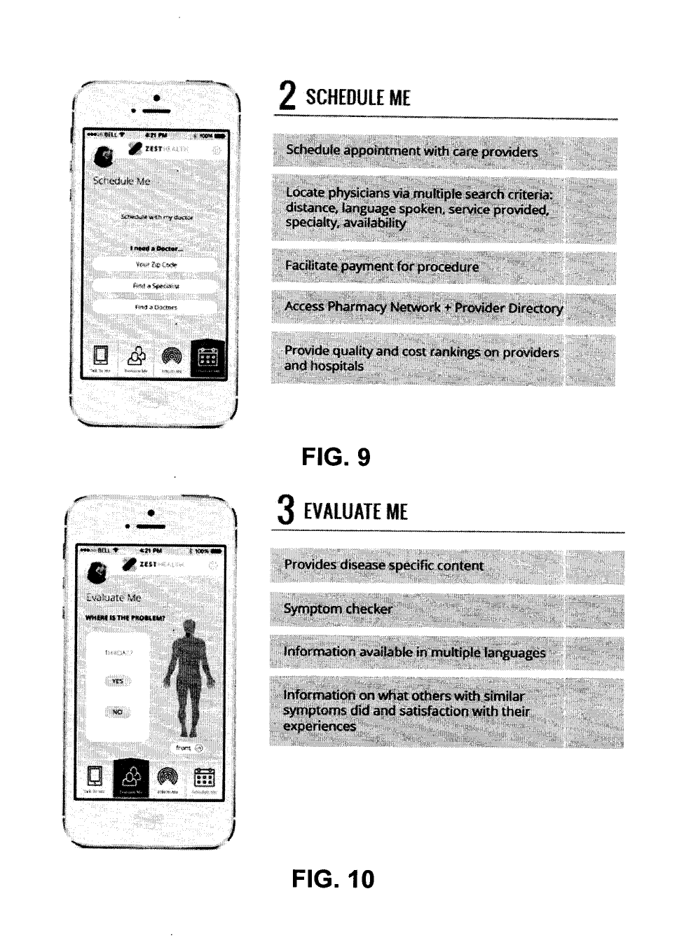

FIG. 9 is a screen shot of the second 302 of the four elements shown at FIG. 7 according to an embodiment of the present disclosure. In the “schedule me” tab 302, the system includes many of the famous calendar functions. By connecting to a database on the server (as for the other elements described herein), information is uploaded. Different indexing tools can be used, such as a localization function on the phone to help determine proximity, the entry of a zip code, or the different entry of specialties needed. The system allows the user to schedule appointments with care providers, locate physicians, facilitate payment for procedures, access pharmacy networks and different provider directories, and provide quality and cost rankings on providers and hospitals.

FIG. 10 is a screen shot of the third 303 of the four elements shown at FIG. 7 according to an embodiment of the present disclosure. With this tool, a user can help diagnose problems, diseases and conditions to maximize the use of the other functions. For example, a user, before talking with a nurse using the ‘talk to me’ function 301, can evaluate himself/herself. The interface can use multiple languages and will index different databases on the servers. As shown, content can be given. By using a body figure as shown, a user can request specific information in an area of concern. Symptoms can be checked and entered. The information can be available in multiple language and using online remote capacity, an online encyclopedia can be accessed.

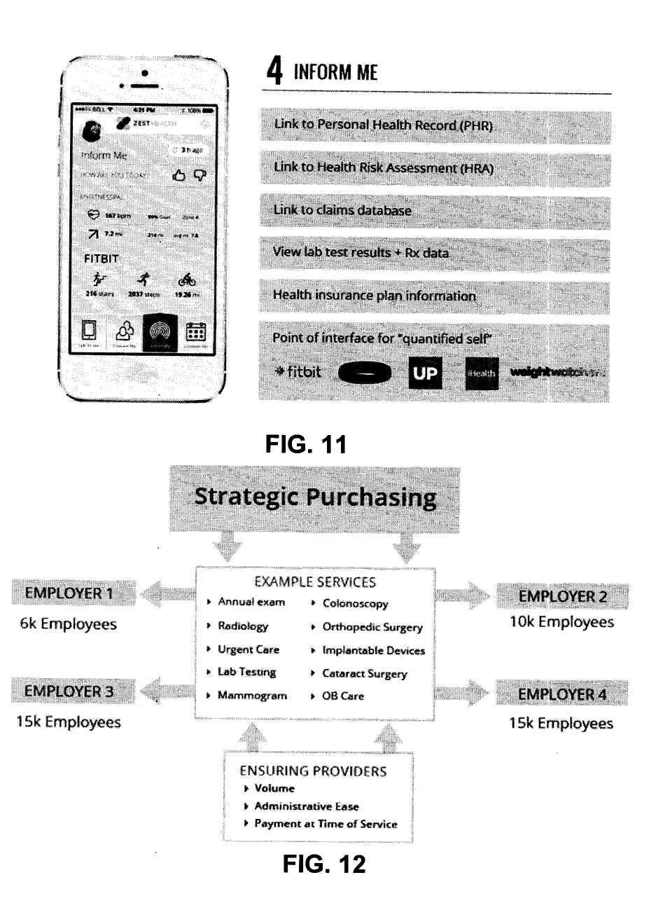

FIG. 11 is a screen shot of the fourth of the four elements 304 shown at FIG. 7 according to an embodiment of the present disclosure. The content of this tab may include many different types of medical-related sources and databases. A user can also include different third-party apps. For example, as shown the tab can include personal health records, a health risk assessment, links to claims databases of insurance companies, lab test results and other medical information, information about a health plan, and other tools such as Fitbit®, Nike Fuel®, etc.

FIG. 12 is a diagram representing the strategy purchasing method according to an embodiment of the present disclosure 500. By accessing a large volume of users over the health care services optimization platform as shown at FIGS. 1-11, many other advantages can be created. For example, strategic purchasing of services, goods or equipment used during services can be accomplished. For example, using volume, administrative ease and payment at the time of service (via a preapproval system with an insurance carrier) 501, the system can purchase and research expensive equipment on behalf of a health care facility. For example, a doctor in private practice who desires to buy five wheelchairs may not get a good price, but if a hundred doctors work in tandem to acquire the goods, a lower price can be secured from the service provider.

The same is true for multiple large employers with multiple employees. If each is asked to use the platform, then by aggregating the health care needs of all employees, lower costs can be achieved. For example, if 0.5% of patients require a mammogram each year, and the system has 50,000 users, the system can determine that it will need equipment and goods associated with 250 mammograms. As shown at 500, multiple employers 1, 2, 3, and 4 illustrated by 502, each will have a different number of employees who have needs to acquire and strategically purchase the goods and services.

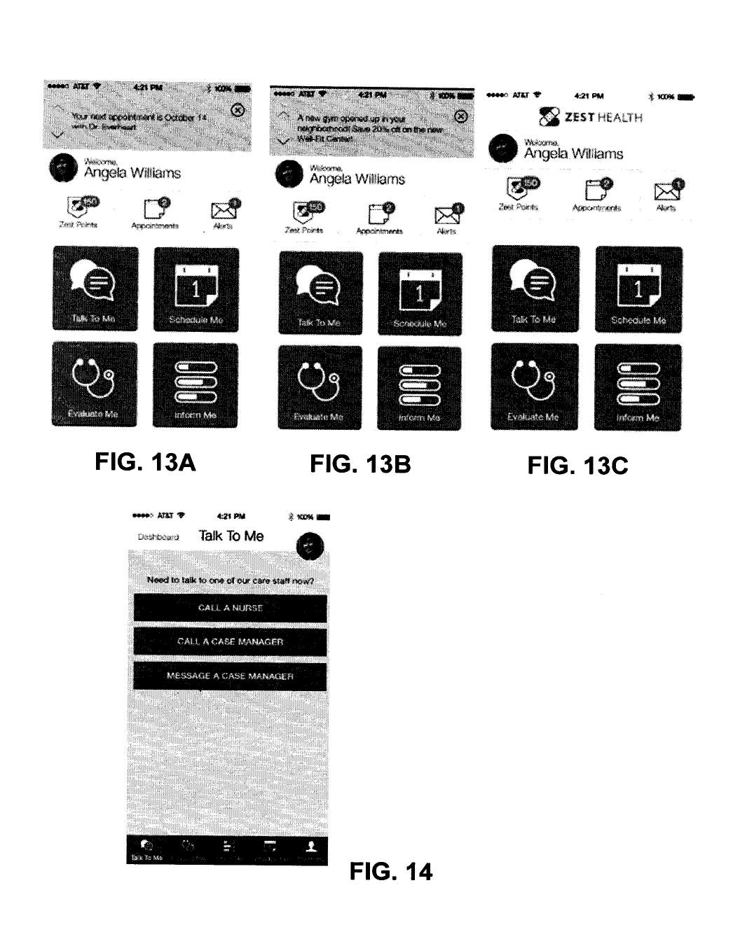

FIGS. 13A to 13C represent three different screen shots, taken from the App highlighting the concept that an advertising and notice area on top 610 of the display can be used as part of a software display according to an embodiment of the present disclosure. In FIG. 13A, the space above the user's profile is used to remind a user of the next appointment; in FIG. 13B the same space gives a user information to help improve health performance (here a gym is advertised along with a promotional code); and finally, at FIG. 13C, simple labeling is used as advertisement space. Also shown in these figures is a system whereby the app operating system is used to help (in red) provide live notices as for different points of interest. Here Ms. Williams 601 is reminded that she owns 150 award points 602, has two appointments 603 and one alert 604.

FIG. 14 is a screen shot of an app software display of the health care services optimization platform showing the “talk to me” 301 element according to an embodiment of the present disclosure. Three buttons are displayed to either contact a nurse 701, contact a case manager 702 or simply leave a message for a case manager 703. These different parties can be predefined in the user setup or can be selected by the home system database of the platform to help provide better and more related services. For example, the system may use a user's location as given by the GPS tracking function of the wireless phone to help locate a user. The system may assign a nurse in the proximity of the user who is on call and has an active status based on a database entry. As shown, the system may be programmed to connect the patient directly with the health care professional.

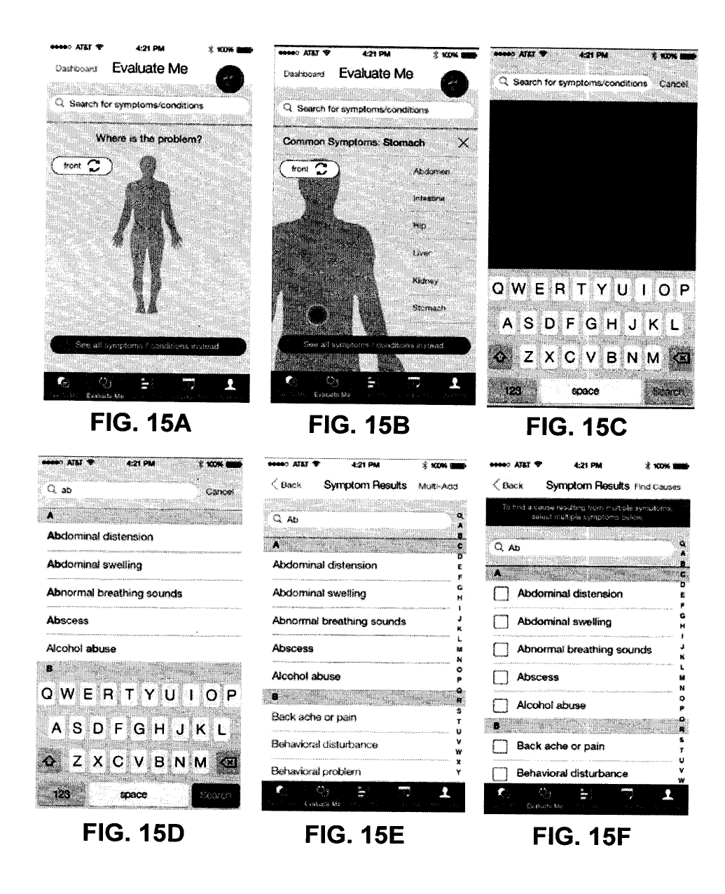

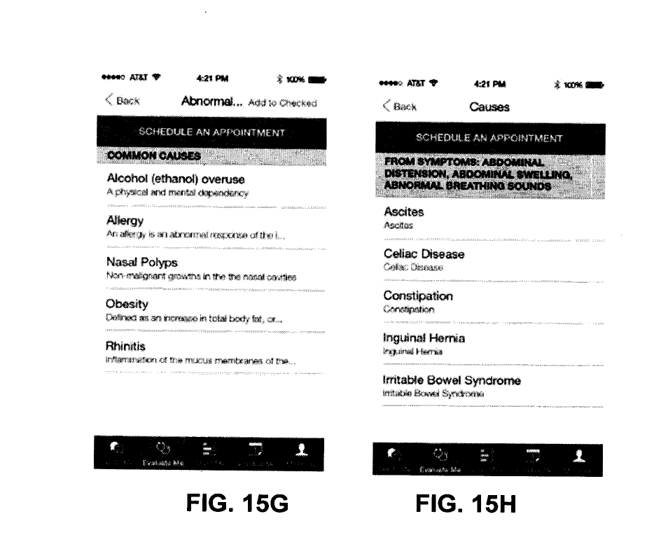

FIGS. 15A to 15H are multiple screen shots of an App software display of the health care services optimization platform showing the “evaluate me” 303 element according to an embodiment of the present disclosure. Part of the problem with medical communications is the lack of medical training of most users. Over the phone, much of the time is wasted by the health care professional asking the same routine questions to help define the applicable problem. While diagnosis is part of medical services, a user's understanding may be heightened to some extent to help facilitate the connection. Software helps offer users with information, but as can be expected, medical information can be very vast, varied, and misleading to the unskilled. For this reason, many medical experts ask patients not to self-diagnose. The current App allows for the system to offer some level of evaluation. The terminology asked by the doctor or the nurse is presented to the patient who can, using the software, lean how to best describe the condition.

By surfing multiple pages, using a simple interface, the patient/user will be able to anticipate the doctor's next questions and offer more constructive data. At FIG. 15A, a user is shown a human body (that of a child, a woman, or a man—not shown), and can be asked to simply touch a portion of a touch screen 801 to indicate which part of the body 802 has symptoms. A button can also rotate the figure to help the user find the right portion of the human form 803. In another way of searching, a search bar 804 allows a user to enter using a keyboard the condition.

In a subsequent step, after a portion of the body is touched 805, as shown at FIG. 15B, a scroll down to the needed condition in an alphabetical list of common symptoms can be offered associated with the location that was touched 806. A user can also type in 807 a symptom as shown at FIG. 15C. Because the name of medical conditions, even when typed by a user who knows generally the name of a condition, a pre-populated list from a database information as shown at FIG. 15D can be offered with the typed portion in bold 808 to help with indexing. At FIG. 15E, the symptoms can be grouped alphabetically or as shown at FIG. 15F, a simple click box can be used to help guide the selection.

While the platform may not be in a position to make a diagnosis, the information entered can be sent directly to the health care professional once a phone connection is established. The information can be used to list the most common causes 809 to help with the schedule of an appointment as shown at FIG. 15G. Often, a patient may have an idea of what type of problem causes the symptoms. As shown at FIG. 15G, a person will know if allergy is a possible suspect. FIG. 15H provides a different interface. One of ordinary skill in the art will understand that while the giving of conditions is possible, each app or interface may be programmed to control the release of information to the patient to prevent incorrect self-diagnosis.

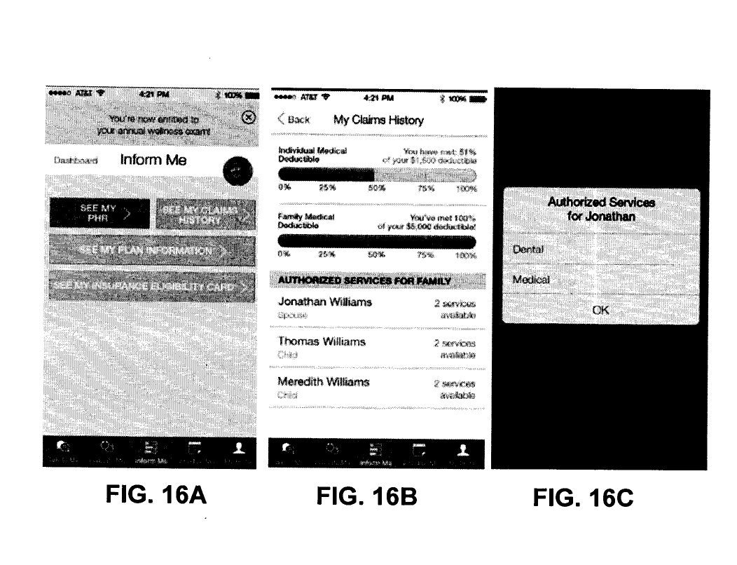

FIGS. 16A and 16B are multiple screen shots of an App software display of the health care services optimization platform showing the “inform me” 304 element according to an embodiment of the present disclosure. As shown, insurance plan information 901 can be entered either by the user or directly by the platform programmer to help a user understand the basic parameters of the plan. For example, plan information and insurance eligibility card information 902 can be accessed. A claim history 903 along with the medical deductible used can be listed along with the different people authorized for services as shown at FIG. 16B.

FIG. 16B allows a user to find out which services are available for a user or his/her dependents. Also, based on the condition entered or diagnosed, a user may obtain information about the costs and treatment options for the conditions, along with the prices for the same service in different health care facilities in the area. Data pertinent to the management of a medical deductible can be given 904. The information can be provided for one individual or for a family as a whole 905. The system can also list what services are available for family members 906.

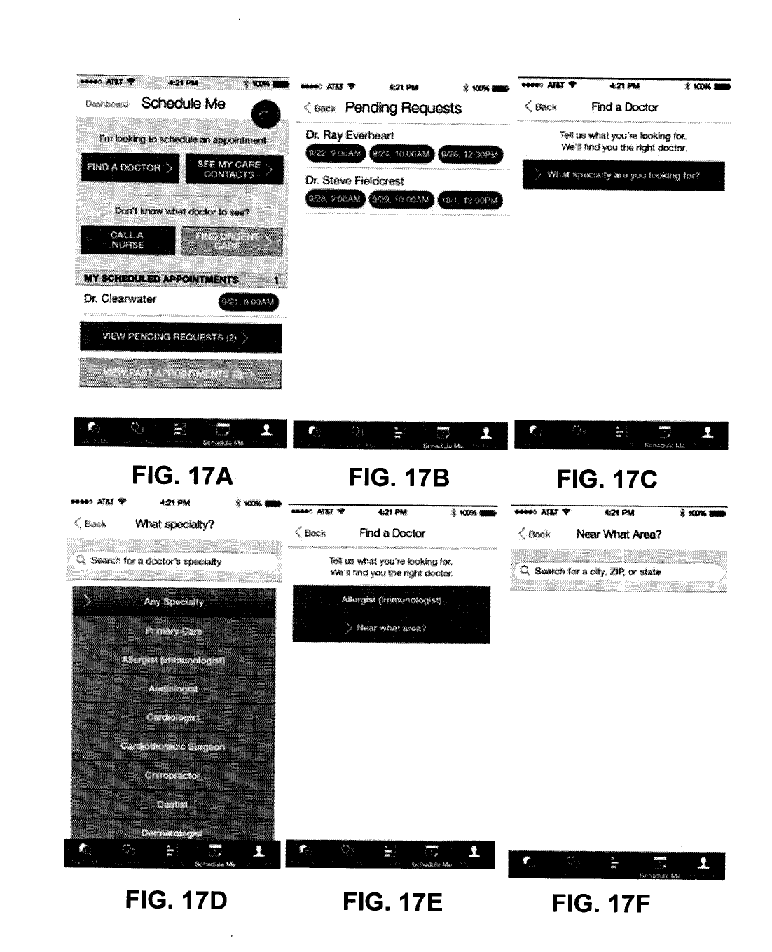

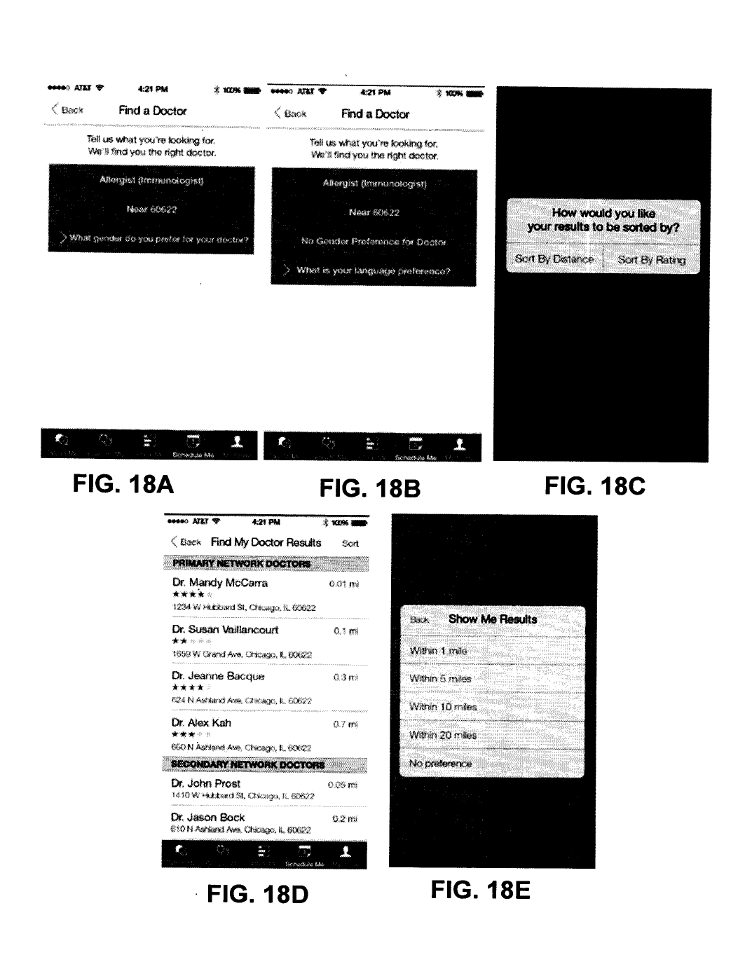

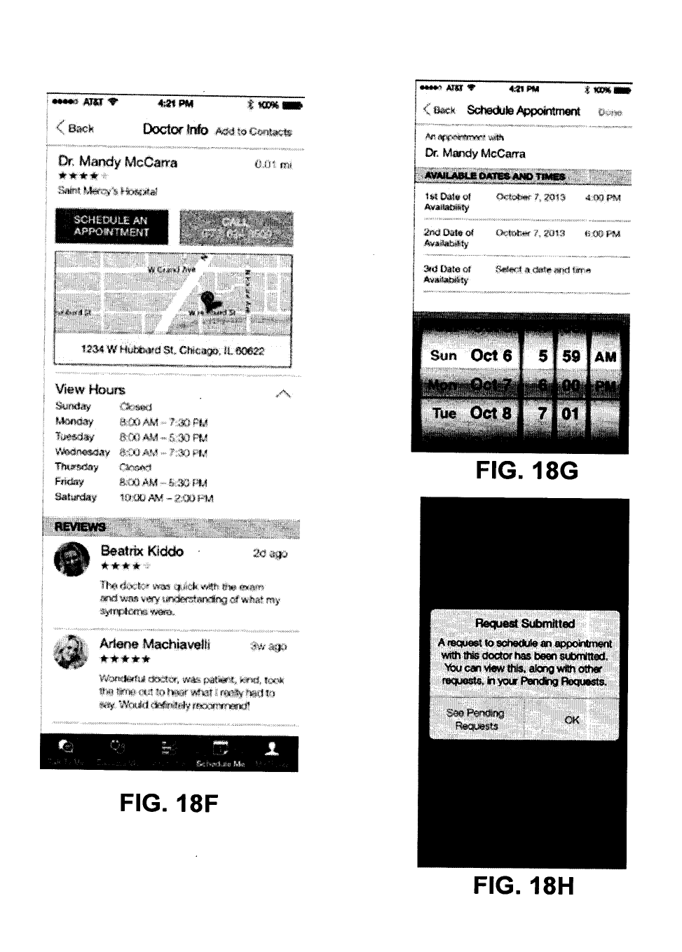

FIGS. 17A-17F and 18A-18H are multiple screen shots of an app software display of the health care services optimization platform showing the “schedule me” 302 element according to an embodiment of the present disclosure. Using multiple cross-indexed databases and external databases of different health care facilities and different doctors, the system will exchange data to allow a user can find a doctor 1001, see the care contacts 1002, call a nurse 1003 or find urgent care 1004 using the app as shown at FIG. 17A. In each case, the user will simply push the button on the user device and the system will pair up with one of these four databases.

FIG. 17B shows how an appointment as shown can either be already scheduled; there may be pending requests or where a party can have pending requests 1005. This principle is not unlike the principle of making restaurant reservations with some additional steps. The system can give a doctor information about a patient, transfer the data entered by the patient, and provide access to part or all of a patient's medical history. Also shown is how different times can be offered by a service provider to help a user select the best option possible.

FIG. 17C shows how the interface helps a user select a doctor. For example, a user as shown at FIG. 17D may be asked to select from a plurality of specialties, then at FIG. 17E the user then indexes the area where care is needed and as shown at FIG. 17F. This search tool can also be adapted based on the insurance plan of the user to allow him/her to select only doctors or physicians that fall within the policy. FIGS. 18A to 18H provide usual ways to help select a physician. As shown at FIG. 18F, doctors or primary physicians can be reviewed or analyzed by past patients. The result of this system is to force doctors and other service providers to offer better customer care.

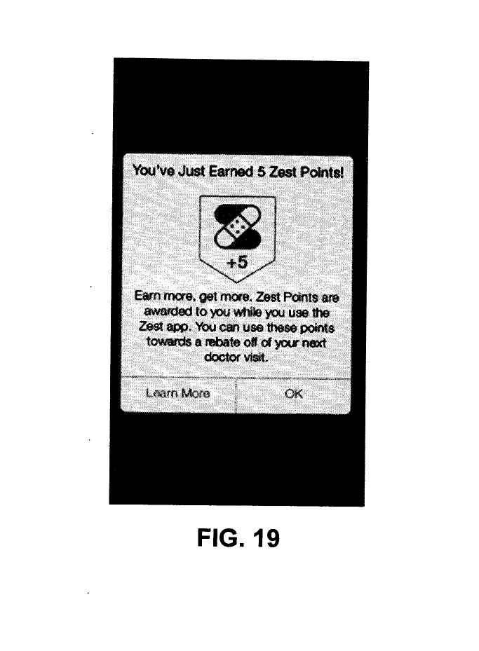

FIG. 19 is a screen shot of an app software display of the health care services optimization platform showing the reward points system according to an embodiment of the present disclosure. As part of using apps and other direct user interfaces, the use of marketing and reward and incentive programs is possible. In this case, users are given ‘points’ to help gain credits for further services.

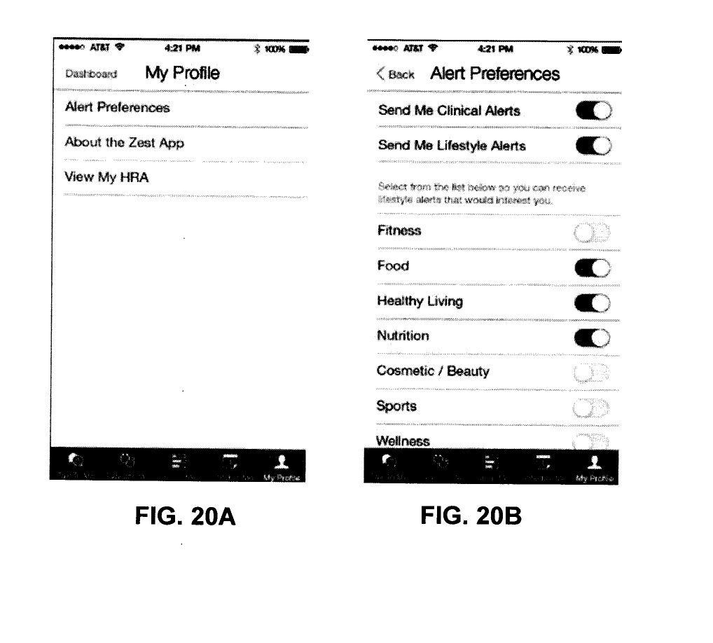

FIGS. 20A and 20B are multiple screen shots of an app software display of the health care services optimization platform showing the “my profile” element according to an embodiment of the present disclosure. These allow a user to set up alerts and preferences for each device used.

What is described in great detail and via the figures is a fully integrated system and platform where a patient, a user 5 as shown at FIG. 1 can interact with his or her doctor or nurse as part of the larger nebula of secondary actors like a health insurance 6 (either private 2, or governmental 3), a supply vendor 7 who offers different goods, a service facility 4 who either houses the doctor or nurse or acts as a large employment center.

The main tool as described is a hardware layer illustrated generally at FIGS. 2, 3, and 4 which houses multiple layers of software illustrated generally at FIGS. 5, to 18. One of ordinary care and skill will understand that while the current embodiment migrates away from a classical computer implement system to a system using cell phones as portable devices and where the software is localized in banks of software, currently sold in the APP format (generally called Apps sold in App stores), the current description also includes all other possible embodiments known in the art. In fact, what is contemplated is a combination of remote portable devices using Apps based tools, web browsing interfaces in HTML protocol, classical software mounted in servers and desk top computers, and tablets also generally in use. For example, a service provider, such as a hospital may decide to customize a software layer to better enable the present invention to operate.

What is describe in part is a health care services optimization platform 200, comprising a hardware layer shown at FIGS. 2-4 used to host and execute a software layer shown in part at FIGS. 5-18 therein, the platform 200 is designed when operating in conjunction with the functionalities of the software to help a patient/user 5 improved and optimize health care services. The platform 200 includes a hardware layer with least one remote server 102 connected to a network communication system 103 like the Internet where the remote server has a remote memory and a remote computer processor (shown 102 as a standalone cabinet) for executing therein a software layer also described as software which serves a purpose, and where the remote server 102 as shown at FIG. 3 stores 201 at least a user version of an App 202 and a service provider version of the App 203 for upload.

As shown at FIG. 2, a plurality of user devices 108 each with inner parts which include a local computer processor, a local memory and a user display shown for example as computer stations 104, 105 for allowing the plurality of users 107 on FIGS. 2 and 5 on FIG. 1, to access the software layer of the at least one remote server 102 via the network communication system 103 and to upload the user version of the App 202 stored in the remote memory of the remote server 102, and wherein each of the plurality of user devices 104, 105 is capable of executing the App in the local memory by the local processor and interact with the user of the user device via a user display (as shown) of the user device used by a user.

Also shown is how a plurality of service provider devices 104, 105 shown on FIG. 3 as 203 each with a provider computer processor, a provider memory and a provider display for allowing the plurality of service providers to access the software layer 208 of the at least one remote server 102, wherein each service provider device 104, 105 is capable of uploading via the network 103 over the software layer the service provider version of the App 203 stored in the remote memory of the remote server 102. In one embodiment, both the user and the provider uses cell phone technology and an App mounted in their respective devices.

The platform 200 also provides that each service provider device 104, 105, is capable of executing the service provider version of the App in the provider memory by the provider computer processor. For example, a doctor or a nurse can upload 203 the App from the App store 201 who will then be able to connected to the user (patient) devices 202. One of ordinary skill in the art will recognize that the software layer of the platform residing and executing in the hardware layer. For example operating systems known in the art residing within the remote memory, the local memory, and the provider memory are executable respectively by the remote computer processors, the local computer processor, and the provider computer processors, when executed allow for the communication and exchange of data between the plurality of user devices.

An software App storage and user interface for storing a plurality of Apps within the memory of the remote memory, for example an App store, for allowing an App retrieval and execution software to upload by the plurality of user devices like cell phones the user version of the App. The same can also be done by the plurality of service provider devices the service provider version of the App, wherein the user version of the App executes in the memory of the local memory by the local computer processor for direct interaction and exchange of data over the network communication system 103 with the service provider version of the App executing in the provider computer processor. The software App also can be designed to upload data over the communication network system 103 from external layers of data from databases as shown at 204, 205, and 206 at FIG. 3.

In one embodiment, both the service provider version of the App and the user version of the App can be the same software but once a user is defined either as a user or a service provider, different functions will be offered. As shown in the figures, the software layer from the perspective of the user is mostly shown. A doctor or service operator will see the mirror image of the different functions as shown. The doctor will see an agenda, will fill in times when he or she wants to be scheduled. Will set up if potential patients can automatically log him or her or the approval process must be done with each request.

The system operates in tandem (i.e. communication bridge between a user and provider) over the network communication network 103 to allow the user as a patient 5 to receive at the user display optimize health care services as shown at FIG. 7 with a means for performing a patient optimize health care service, the service including a software interface with a talk-to-me function 301, a schedule-me function 302, an evaluate-me function 303, and an inform-me function 304. As described above, these functions allow a user, normally a patient to expedite several key aspects of health care related services by informing the client, coordinating the communication between the client and a service expert, by setting up the calendar and by helping the patient get a better grasp of his or her condition.

As shown with greater detail at FIG. 8, the talk-to-me function 301 is a means for communication between at least a user 5 and a service provider 4 and includes a primary assigned medical service provider 401 for contact over a phone line, email, or video conference, and a secondary medical service provider 402 for contact over a phone line, email, or video conference. This process is easy to understand. For example, if a patient falls and hurts himself during a bike ride, the person might first use a user device to call 911 and get the emergency contact on their way. In addition to performing normally scheduled meetings, the user can simply push to talk to the doctor 401 or the nurse 402 of his or her preference to help get help as the ambulance arrives. As shown, these people can be selected from a group consisting of a doctor, a nurse, and a case manager.

As shown at FIG. 9, the schedule-me function 302 is a software interface which includes the function of entry of a zip code, a choice between scheduling a doctor, a care contact, a nurse, or urgent care, and wherein the function of entry of a doctor includes the entry of a specialty, the gender of the service provider, and a language preference. FIG. 17 is helpful to understand this function with greater clarity.

As shown at FIG. 17B, the function of entry of a doctor includes the entry of available dates and times, a selection of a pre-selected doctor after the geographical data of a doctor's location and a third party review of the doctor. The schedule-me function 302 also can include a graphical human body interface to select a zone of interest of a medical problem, a choice of common symptoms, and a tool to index different symptom results. It can also include a selection for claims history, includes information about a medical deductible, and a family deductible based on the policy, a selection to see plan information, a selection to see an insurance eligibility card.

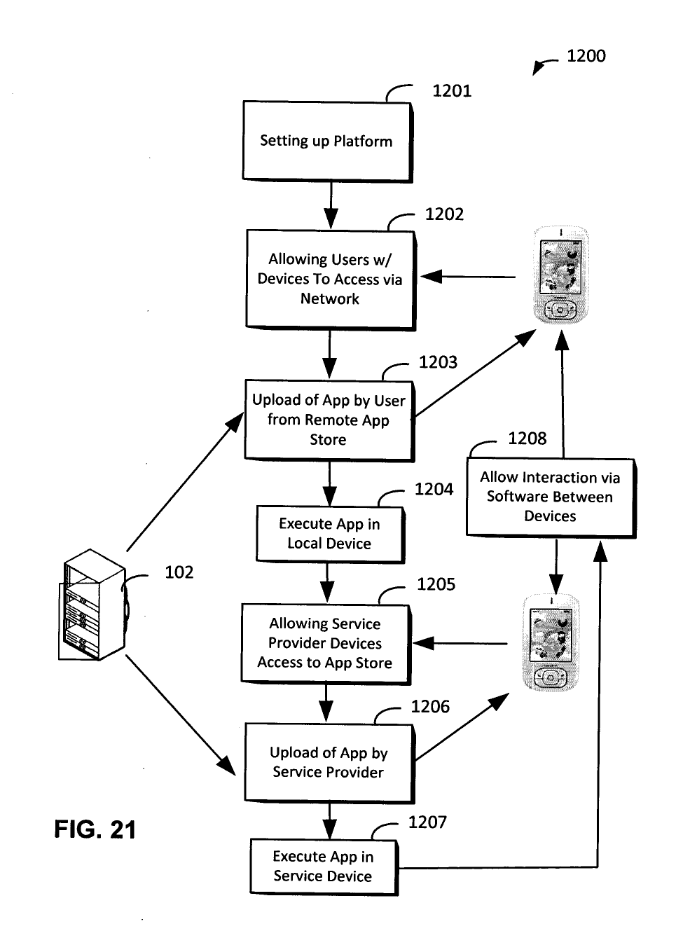

FIG. 21 shows a method 1200 for providing optimized health care services over a health care services optimization platform, on a platform set-up as defined above 1201 upon which the method is performed, the method comprising the steps of allowing 1202 a plurality of users, each using one of the plurality of user devices to access the software layer of the at least one remote server via the network communication system, uploading 1203 by each of the plurality of users, within the local memory of the user device the user version of the App stored in the remote memory of the remote server, executing 1204 in the local computer processor the user version of the App, allowing 1205 a plurality of service providers, each using one of the plurality of service provider devices to access the software layer of the at least one remote server via the remote network communication system, uploading 1206 by each of the plurality of service providers, within the provider memory of the service provider devices the provider version of the App stored in the remote memory of the remote server, executing 1207 the user version of the App, and allowing 1208 the user to interact with the service provider as shown by lines via the platform by using at the App interface on the user display a combination of a talk-to-me function 1301, a schedule-me function 1302, an evaluate-me function 1303, or an inform-me function 1304.

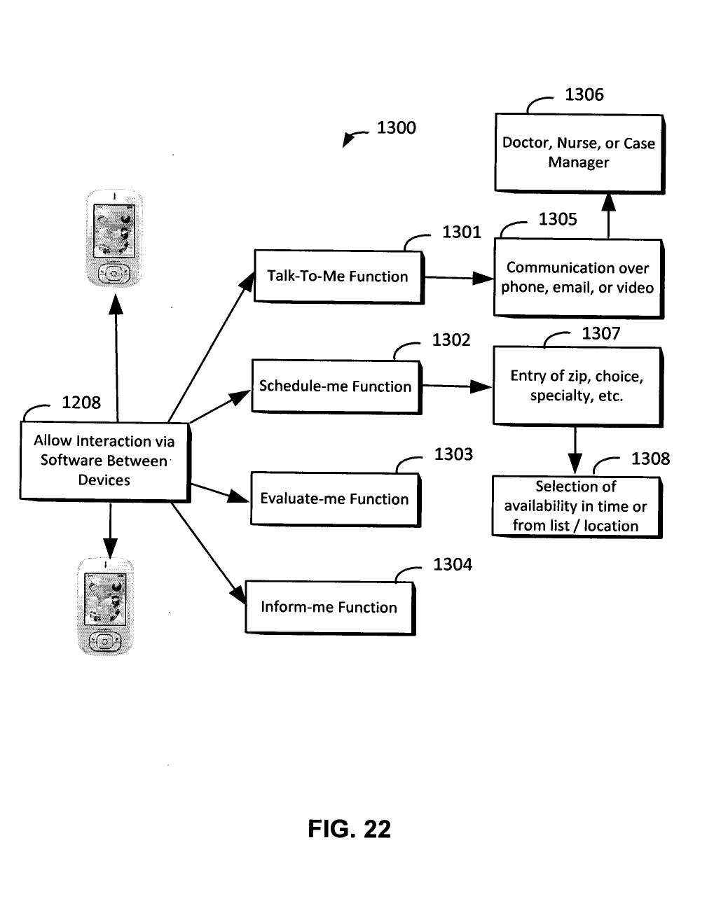

The step of user interaction with the talk-to-me function 1301 as shown at FIG. 22, includes the step of communication 1305 between at least a user and a service provider and includes a primary assigned medical service provider for contact over a phone line, email, or video conference, and a secondary medical service provider for contact over a phone line, email, or video conference and a person from a group consisting 1306 of a doctor, a nurse, and a case manager.

In another embodiment, the step 1302 includes 1307 of entry of a zip code, a choice between scheduling a doctor, a care contact, a nurse, or urgent care, and further includes the step of entry of a specialty, the gender of the service provider, and a language preference. As shown, the step of selection of a doctor 1307 can includes the step 1308 of selecting one available date and time from a list of available dates and times, selecting one doctor from a pre-selected group of doctor offered to the user based on a geographical data of a doctor's location, a doctor includes the steps of selecting one doctor from a pre-selected group of doctor offered to the user based on a geographical data of a doctor's location.

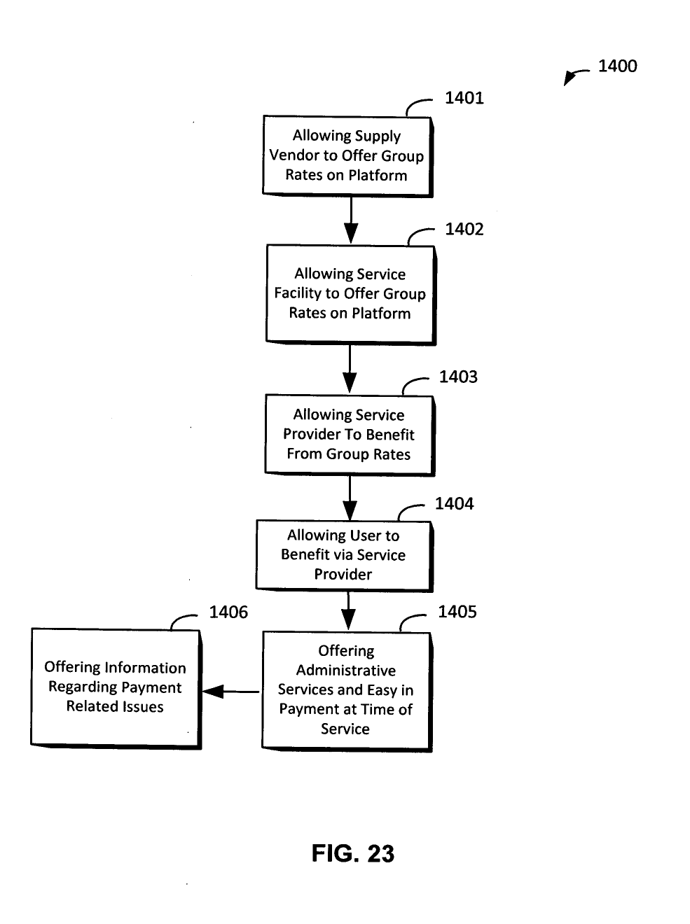

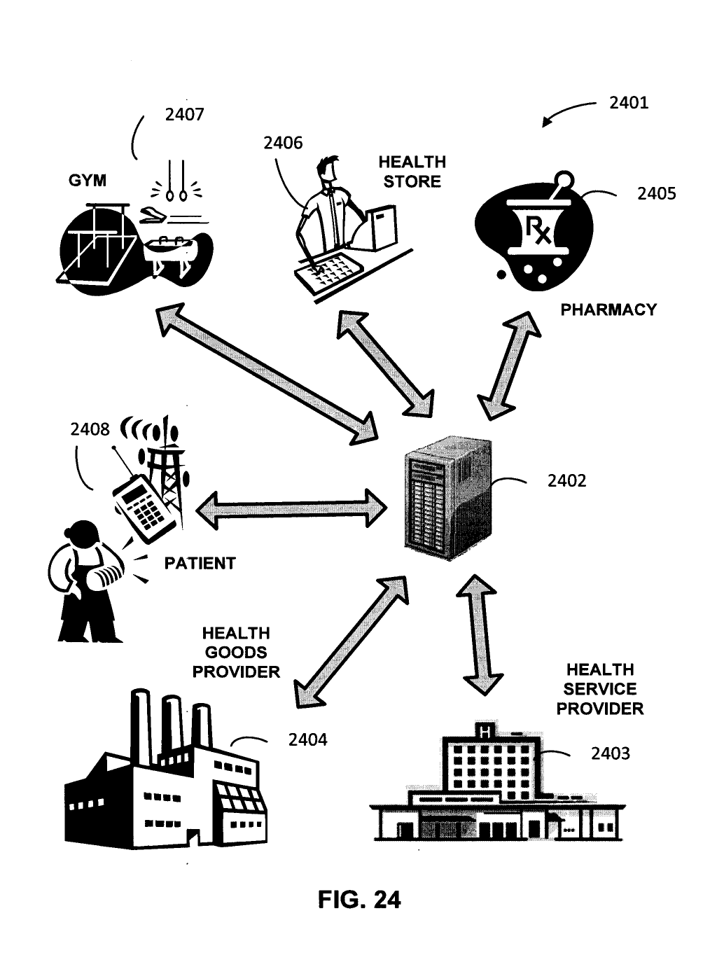

FIG. 23 is directed to a method for allowing strategic purchasing 1400 from supply vendors by a service facility using an optimized health care services optimization platform, the service including allowing 1401 at least a supply vendor to offer group rates for the supply of medical-related goods, allowing 1402 at least a service facility to offer group rates for the supply of medical-related services, allowing 1403 at least one service provider to benefit from the group rates for the supply of medical-related goods or the medical-related services as part of its own services, to offer group rates to the user, and allow 1404 a user to access the service provider and benefit from the group rates offered. In another embodiment, the method 1400 includes the step of offering 1405 to the service provider an additional benefit by offering administrative services and ease of payment at the time of service or the step 1406 of offering information to the user regarding payment-related issues, including data relating to past spending on deductible costs.

What is contemplated in the current invention is a dual system, where on each of the two parrallel systems, a different incentive is offered, and where both incentives are crossed in interest. The system, called the HealthMall^{SM} has two distinct tracks. The first offers different goods/services, each health-related. For example, these goods and services can include different contacts to massages, healthy foods, health-related equipment, trips, etc. A user can buy directly goods/services using this track, but may also use ‘Zest-bucks’ which are credit-based points given to the user either for a purchase on this track or the second track described below.

The second portion of the software application is designed as a menu where different expensive health-care-related services are offered at a group/discounted rate. For example, some tests or other services can come with a high deductible, or some patients may be faced with price quotas or limitations. For example, the average cost of an Abdominal MRI is $2,625.00 in the Chicago area. The person offering the online interface services contacts MRI service providers and negotiates either a group rate (i.e., 30% off in certain locations), a rate discounted based on the moment the service is available (i.e., 30% off from 6 to 7 pm.), or a combination of both.

In addition to offering these services at a discounted rate, what is contemplated is the offering credits to the user on one side that they can use on the other side and vice-versa. For example, the online interface provider may contact an MRI provider service provider. This provider has peak hours and off-peak hours. Wanting to drive off-hour customers, the MRI signs up with the online interface and releases for the next week 20 appointments in the hours of 8 to 12 pm at night. While these services are normally charged X, they are offered on the interface at a discounted rate of X−30%. In addition, a user can buy one of these deals which in turn will earn it X credits in the interface. These credits will then be usable anywhere on the interface to buy in full any good/service, or as the basis of a price reduction of the good/service.

In the above example, if the Abdominal MRI is normally $2,625.00, it can be offered to customers for $1,837 (70% of the full price). A client may pay directly on the interface which in turn will earn it 183 Zest-bucks usable to purchase other goods and services. In another embodiment, the user can be a third party such as a doctor, a nurse, or a retirement home owner. In the case of a retirement home owner, with multiple guests each having different medical needs, the user will simply be able to surf the interface, compare the cost of services with the online market price and offer an alternative to the guest. For example, a person with kidney problems must often get 14-18 hours of dialysis each week. The online interface could offer dialysis at home for the price of a hospital-based treatment as long as the hours are limited. Using the system described here, the retirement home owner would offer the patient the alternative of an in-room treatment at a different hour from a service provider with mobile equipment. If the service is purchased by the location operator, that individual would accumulate the reward points which could only be used to get health-related services or goods either for himself/herself or for the retirement home.

From the perspective of a service provider, this platform is beneficial in multiple ways. Each service provider in the health care industry has purchasing needs of some type. By using the interface, revenues can be generated which can be exchanged using the reward system for other services. For example, the owner of an MRI facility may wish to use 10% of its capacity on the interface to generate points or credits in turn that can be used to acquire services and/or goods needed by the facility. For example, the facility purchases laundry, clothing and medical supplies needed to run MRIs of different portions of the body. By using the interface, a barter type of system can be created.

Finally, FIG. 24 shows such a marketplace 2400 where different actors will converge onto a common interface system 2402. On one end, the user 2408, using a wireless or any other type of technology will log into the interface system 2402 to take part in the marketplace and the exchange. As shown, health service providers, like hospitals, different test centers, hospices, retirement homes, therapists, and others 2403 can be connected to the marketplace 2400. Health goods providers 2404, such as large device suppliers, bed suppliers, tools suppliers, etc. can also converge on the marketplace 2400. Shown above are secondary providers such as pharmacies 2405, health stores 2406, or even gyms 2407 each having a focus related to the good health of a patient can also be made to converge onto the marketplace 2400 to offer and exchange their goods and services.

What is also contemplated is a method of generating revenues using an online health-care marketplace, the method comprising the steps of allowing a plurality of health care service providers to offer a first type of services at a first price listed under a first segment of a health exchange market for purchase by a user at the first price, wherein an online health-care marketplace operator takes a first commission on the first price and gives the health care service provider the first price minus the first commission, and, based on the first price giving a first credit to the user for use in a second segment of the health exchange market. This allows a plurality of health-related service providers to offer a second type of goods or services at a second price to be listed under the second segment of the health exchange market for purchase by the user using the first credit given the user, wherein the value of the first credit is inferior to the first commission.

What is also contemplated are different substeps which include allowing the operator to make a commission on the second price to be listed under the second segment of the health exchange by paying to the health-related service provider a value for the goods sold at the second price reduced by a second commission. The third way to leverage this method is to allow the goods and services to be offered at the second price be only partly paid by the first credit of the user.

Building on the system and novel functions shown above and in the supporting figures, a marketplace 2400 is created and offered to users. What is contemplated is a single location using an application in which a service provider can leverage its own services and goods to buy related services or goods. For example, a gym can offer membership on the marketplace by listing each membership at, for example, $100/month under a first segment of the exchange 2400. A user may purchase at $100 and the marketplace operator will take a first commission (for example $5) and give the gym only $95 (the purchase price minus the commission). In this example, the user who purchased the membership and paid $100 is given a credit to be used in a second part of the exchange, for example $2 for purchase. The gym owner can also offer a second type of services or goods to allow the user who purchased the first service to spend the credit i.e., the gym can offer coaching services at $100/hour.

While the use of credits is well known, in the context of health-care related goods and services it is not. While one embodiment is disclosed, what is contemplated is the use in many other contents.

It is understood that the preceding is merely a detailed description of some examples and embodiments of the present invention and that numerous changes to the disclosed embodiments may be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A health care marketplace platform, comprising a hardware layer used to host and execute a software layer therein, the platform designed to operate in conjunction with the functionalities of the software to help market health care services,
(a) the hardware layer of the platform comprising:
at least one remote server connected to a network communication system with a remote memory and a remote computer processor for executing therein a software layer and for storing at least a user version of an App and a service provider version of the App for upload;
a plurality of user devices each with a local computer processor, a local memory and a user display for allowing the plurality of users to access the software layer of the at least one remote server via the network communication system and to upload the user version of the App stored in the remote memory of the remote server, and wherein each of the plurality of user devices is capable of executing the App in the local memory by the local processor and interacting with the user of the user device via a user display of the user device utilized by a user; and
a plurality of service provider devices each with a provider computer processor, a provider memory and a provider display for allowing the plurality of service providers to access the software layer of the at least one remote server, wherein each service provider device is capable of uploading via the network over the software layer the service provider version of the App stored in the remote memory of the remote server, and wherein each service provider device is capable of executing the service provider version of the App in the provider memory by the provider computer processor;
(b) the software layer of the platform residing in and executing from the hardware layer comprising:
one layer of operating systems residing within the remote memory, the local memory, and the provider memory executable, respectively, by the remote computer processors, the local computer processor, and the provider computer processors, and, when executed allow for the communication and exchange of data between the plurality of user devices, the plurality of service provider devices and the remote server via the network communication system; and a software App storage and user interface for storing a plurality of Apps within the memory of the remote memory, for allowing an App retrieval and execution software to upload by the plurality of user devices the user version of the App, and upload by the plurality of service provider devices the service provider version of the App, wherein the user version of the App executes in the memory of the local memory by the local computer processor for direct interaction and exchange of data over the network communication system with the service provider version of the App executing within the provider computer processor, and wherein the App also uploads data over the communication network system from external layers of data from databases; and
(c) the service provider version of the App and the user version of the App operating in tandem over the network communication network to allow the user to receive at the user display health care marketplace services with a means for performing a service, the service including a software interface allowing a plurality of healthcare providers to offer a first type of service at a first price listed under a first segment of a health exchange market for purchase by a user at the first price, wherein an online health-care marketplace operator takes a first commission on the first price and gives the health care service provider the first price minus the first commission;
the software interface further, based on the first price, giving a first credit to the user for use in a second segment of the health exchange market; and
the software interface further allowing a plurality of health-related service providers to offer a second type of goods or services at a second price to be listed under the second segment of the health exchange market for purchase by the user using the first credit given the user, wherein the value of the first credit is inferior to the first commission.

2. The healthcare marketplace of claim 1, wherein the second type of goods or services is a fraction of a total capacity of goods or services offered by the health care service provider.

3. The health care marketplace of claim 2, wherein the first credit given is an electronic credit currency.

4. The health care marketplace of claim 1, wherein the first credit is half of the first commission.

5. The health care marketplace of claim 1, wherein the first commission is five percent of the first price.

6. A method of generating revenues using a health care market place, the method compromising the steps of and allowing a plurality of healthcare providers to use a healthcare marketplace, the marketplace comprising:
a health care marketplace platform, comprising a hardware layer used to host and execute a software layer therein, the platform designed when operating in conjunction with the functionalities of the software to help market health care services, (a) the hardware layer of the platform comprising: at least one remote server connected to a network communication system with a remote memory and a remote computer processor for executing therein a software layer and for storing at least a user version of an App and a service provider version of the App for upload; a plurality of user devices each with a local computer processor, a local memory and a user display for allowing the plurality of users to access the software layer of the at least one remote server via the network communication system and to upload the user version of the App stored in the remote memory of the remote server, and wherein each of the plurality of user devices is capable of executing the App in the local memory by the local processor and interacting with the user of the user device via a user display of the user device utilized by a user; and a plurality of service provider devices each with a provider computer processor, a provider memory and a provider display for allowing the plurality of service providers to access the software layer of the at least one remote server, wherein each service provider device is capable of uploading via the network over the software layer the service provider version of the App stored in the remote memory of the remote server, and wherein each service provider device is capable of executing the service provider version of the App in the provider memory by the provider computer processor; (b) the software layer of the platform residing in and executing from the hardware layer comprising: one layer of operating systems residing within the remote memory, the local memory, and the provider memory executable, respectively, by the remote computer processors, the local computer processor, and the provider computer processors, and, when executed allow for the communication and exchange of data between the plurality of user devices, the plurality of service provider devices and the remote server via the network communication system; (c) a software App storage and user interface for storing a plurality of Apps within the memory of the remote memory, for allowing an App retrieval and execution software to upload by the plurality of user devices the user version of the App, and upload by the plurality of service provider devices the service provider version of the App, wherein the user version of the App executes in the memory of the local memory by the local computer processor for direct interaction and exchange of data over the network communication system with the service provider version of the App executing in the provider computer processor, and wherein the App also uploads data over the communication network system from external layers of data from databases; and (d) the service provider version of the App and the user version of the App operating in tandem over the network communication network to allow the user to receive at the user display healthcare marketplace services with a means for performing a service, the service including a software interface allowing a plurality of healthcare providers to offer a first type of service at a first price listed under a first segment of a health exchange market for purchase by a user at the first price, wherein an online health-care marketplace operator takes a first commission on the first price and gives the health care service provider the first price minus the first commission; the software interface further, based on the first price, giving a first credit to the user for use in a second segment of the health exchange market; and the software interface further allowing a plurality of health-related service providers to offer a second type of goods or services at a second price to be listed under the second segment of the health exchange market for purchase by the user using the first credit given the user, wherein the value of the first credit is inferior to the first commission; and
giving a first credit to the user, and allowing a plurality of health related service providers to offer a second type of goods or services at a second price to be listed under the second segment of the health exchange market for purchase by the user using the first credit given the user, wherein the value of the first credit is inferior to the first commission.
